(19) United States
(12) Patent Application Publication
(10) Pub. No.: US 2021/0352182 A1
(43) Pub. Date: Nov. 11, 2021

(54) IMAGE PROCESSING DEVICE, IMAGE FORMING DEVICE AND RECORDING MEDIUM

(71) Applicant: KONICA MINOLTA, INC., Tokyo (JP)

(72) Inventor: Yoriko NODA, Hino-shi, Tokyo (JP)

(73) Assignee: KONICA MINOLTA, INC., Tokyo (JP)

(21) Appl. No.: 17/313,071

(22) Filed: May 6, 2021

(30) Foreign Application Priority Data
May 7, 2020 (JP) 2020-081661

(51) Int. Cl. H04N 1/00

(52) U.S. Cl. CPC H04N 1/00204; H04N 1/00413; H04N 2201/0094; H04N 1/00482; H04N 1/00477; H04N 1/00474

(57) ABSTRACT

An image processing device includes a job entry unit, a link setter, and an association setter. The job entry unit enters jobs. The link setter associates the jobs entered by the job entry unit. The association setter associates one or more items common to the associated jobs.

### BACKGROUND

### 1. Technological Field

The present invention relates to an image processing device, an image forming device, and a recording medium.

### 2. Description of the Related Art

Conventionally, known decorative print includes two types of jobs, i.e., a sketch job of printing sketches and an additional print job of performing additional print.

In decorative print, paper is first placed on a feed tray of an image forming device, and black image print is performed for hot stamping. The paper on which the black image print is performed for the hot stamping is manually carried to a hot stamper. Hot stamping is performed on the paper. The hot-stamped paper is manually carried to the image forming device, and the paper is set again in the feed tray of the image forming device for additional printing.

The sketch jobs and the additional print jobs are independent of each other. When jobs are edited on a job edit screen, values common to both jobs are entered in some items. Examples of such items are image position (image shift) adjustment, magnification adjustment, a paper setting (paper type, weight, etc.), a setting of the number of copies, replacement of image pages, and the like. On the other hand, values different between the sketch job and the additional print job are entered in items such as colors of tone curve adjustment and image quality adjustment.

For example, JP2013-86285A discloses link setting as a technique for easily managing jobs as associated jobs. The link setting associates a newly entered job with a stored job, or associates jobs stored in a job storage with each other while each associated job remains independent.

In a case where the link setting of the sketch job and the additional print job is performed according to the technology described in JP2013-86285A, contents of the jobs need to be edited separately though the jobs include many common items. It brings a problem of troublesome work.

### SUMMARY

An object of the present invention is to effectively edit contents of items of jobs on which the link setting is performed.

To achieve at least one of the abovementioned objects, according to an aspect of the present invention, an image processing device includes:

a job entry unit that enters jobs;

a link setter that associates the jobs entered by the job entry unit; and

an association setter that associates one or more items common to the associated jobs.

According to another aspect of the present invention, a non-transitory recording medium stores a computer readable program that makes a computer of an image processing device function as:

a job entry unit that enters jobs;

a link setter that associates the jobs entered by the job entry unit; and

an association setter that associates one or more items common to the associated jobs.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 schematically shows an overall configuration of an image forming device according to the embodiment.

FIG. 2 is a block diagram showing a functional configuration of the image forming device.

FIG. 3 is a flowchart showing link setting processing for jobs.

FIG. 4 shows an example of a job list screen.

FIG. 5 is a flowchart showing job edit processing.

FIG. 6 shows a job information edit screen without associated items.

FIG. 7A shows an example in which associated items are displayed in a distinguishable manner

FIG. 7B shows an example of a display in which associated items are connected by lines.

FIG. 8 shows an example of displaying items of one of the two associated jobs, the items being not allowed to be changed.

FIG. 9 shows a job information edit screen in which two jobs are displayed at once.

FIG. 10 is a flowchart showing automatic change processing for contents of associated items.

FIG. 11A shows an example of pop-up display and message display.

FIG. 11B shows an example of flashing of a mark on an item.

FIG. 11C shows an example of pop-up display that informs automatic change when a second job is opened for the first time after contents of items of the second job are automatically changed.

FIG. 12 is a flowchart showing mismatch notification processing for contents of associated items.

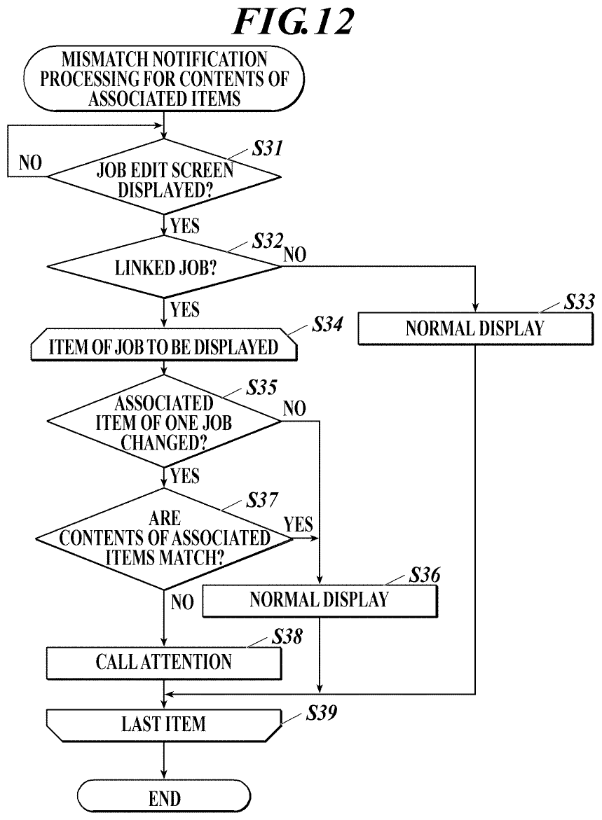

### DETAILED DESCRIPTION OF EMBODIMENTS

Hereinafter, one or more embodiments of the present invention will be described with reference to the drawings. However, the scope of the invention is not limited to the disclosed embodiments.

Configuration of Image Forming Device

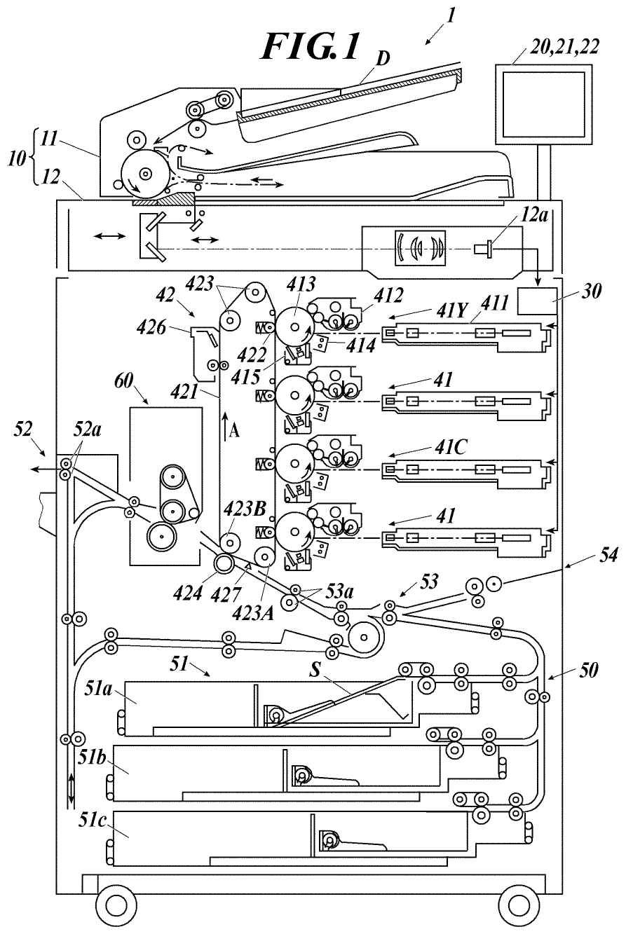

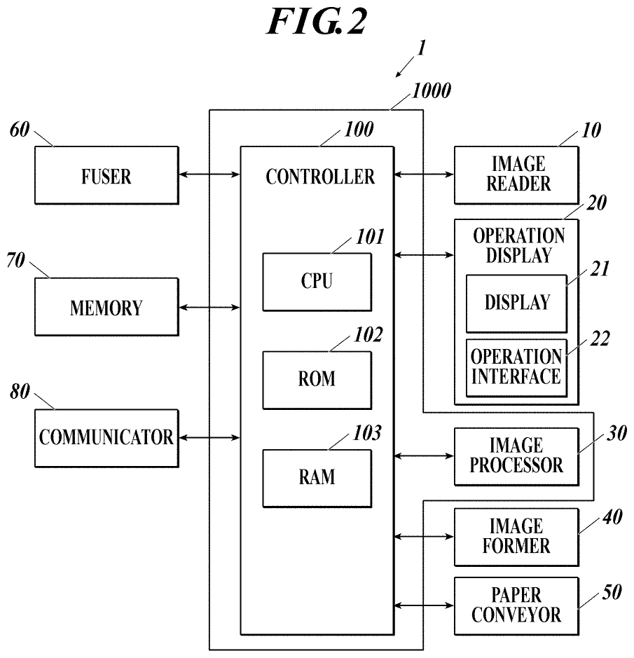

FIG. 1 schematically shows an overall configuration of an image forming device 1 according to an embodiment. FIG. 2 is a block diagram showing a main functional configuration of the image forming device 1 according to the embodiment.

The image forming device 1 shown in FIGS. 1 and 2 is a color image forming device in an intermediate transfer method using electronic photography process technology. The image forming device 1 transfers (primary transfer) color toner images of Y (yellow), M (magenta), C (cyan), and K (black) formed on photosensitive drums 413 to an intermediate transfer belt 421. The image forming device 1 piles the toner images of four colors on the intermediate transfer belt 421 and then transfers it to paper (secondary transfer). Thus, the image forming device 1 forms an image.

In the image forming device 1, the photosensitive drums 413 corresponding to the four colors YMCK are arranged in series in a travel direction of the intermediate transfer belt 421. A tandem method in which toner images of colors are sequentially transferred is adopted for the intermediate transfer belt 421.

As shown in FIG. 2, the image forming device 1 includes an image reader 10, an operation display 20, an image processor 30, an image former 40, a paper conveyor 50, a fuser 60, memory 70, a communicator 80, and a controller 100.

The image reader 10 includes an automatic document feeder 11 called ADF, and a document image scanner 12.

The automatic document feeder 11 conveys a document D placed on a paper tray with a conveyance mechanism to send it to the document image scanner 12. The automatic document feeder 11 continuously reads a large number of images of the document D (including images on both sides) placed on the paper tray at once.

The document image scanner 12 optically scans a document conveyed from the automatic document feeder 11 onto the contact glass or scans a document placed on the contact glass. The document image scanner 12 focuses light reflected from the document on a light receiving surface of a CCD (charge coupled device) sensor 12a to form an image. Thus, the document image scanner 12 reads a document image. The image reader 10 generates input image data based on the reading result of the document image scanner 12. A predetermined image processing is applied to the input image data in the image processor 30.

The operation display 20 includes, for example, a liquid crystal display (LCD) with a touch panel, and functions as a display 21 and an operation interface 22. The display 21 displays various operation screens, image status, operation statuses of various functions, and the like according to display control signals inputted from the controller 100. The display 21 functions as a display unit. The operation interface 22 includes various operation keys such as a numeric keypad and a start key. The operation interface 22 accepts various input operations by a user and outputs operation signals to the controller 100.

The image processor 30 includes a circuit for digital image processing according to an initial setting or a user setting for image data (input image data) of an entered job. For example, the image processor 30 corrects a tone based on tone correction data (tone correction table) under the control of the controller 100. In addition to the tone correction, the image processor 30 performs various correction processing such as color correction and shading correction, compression processing, and the like on input image data. The image former 40 is controlled based on image data on which the above processing is performed.

The image former 40 includes:

image forming units 41Y, 41M, 41C, 41K that form images with color toners of Y component, M component, C component, and K component based on the input image data on which image processing has been performed; and

an intermediate transfer unit 42.

The image forming units 41Y, 41M, 41C, 41K for Y component, M component, C component, and K component have the same configurations. For convenience of illustration and explanation, common components are shown with the same symbol. Y, M, C, or K are added to symbols for distinction. In FIG. 1, symbols are given only to components of the image forming unit 41Y for the Y component. Symbols are omitted for components of other image forming units 41M, 41C, 41K.

The image forming unit 41 includes an exposure device 411, a development unit 412, a photosensitive drum 413 (image carrier), a charger 414, and a drum cleaning device 415.

The photosensitive drum 413 is a negatively charged organic photo conductor (OPC). An undercoat layer (UCL), a charge generation layer (CGL), and a charge transport layer (CTL) are sequentially laminated on a circumference of, for example, an aluminum conductive cylinder (aluminum tube). The charge generation layer consists of an organic semiconductor in which a charge generating material (for example, phthalocyanine pigment) is dispersed in a resin binder (for example, polycarbonate). The charge generation layer generates a pair of positive and negative charges in response to exposure by the exposure device 411. The charge transport layer consists of a material in which a hole transport material (electron-donating nitrogen-containing compound) dispersed in a resin binder (for example, a polycarbonate resin). The charge transport layer transports the positive charge generated by the charge generation layer to a surface of the charge transport layer.

The controller 100 rotates the photosensitive drum 413 at a constant circumferential speed (for example, 665 mm/s) by controlling a drive current supplied to a drive motor (not shown) that rotates the photosensitive drum 413.

The charger 414 uniformly and negatively charges a surface of the photosensitive drum 413 having photoconductivity. The exposure device 411 is, for example, a semiconductor laser. The exposure device 411 irradiates the photosensitive drum 413 with laser beam corresponding to an image of each color component. A positive charge is generated in the charge generation layer of the photosensitive drum 413 and is transported to the surface of the charge transport layer. Thereby, the charge (negative charge) on the surface of the photosensitive drum 413 is neutralized. An electrostatic latent image of each color component is formed on the surface of the photosensitive drum 413 by potential difference from surroundings.

The development unit 412 is a development unit of the two-component development method in which a two-component developer including a toner and a carrier is used. The development unit 412 visualizes an electrostatic latent image by attaching toner of each color component to the surface of the photosensitive drum 413. Thus, the development unit 412 forms a toner image.

After the toner image is secondarily transferred to paper, the fuser 60 heats and applies pressure to the conveyed paper with a fusing nip. Thereby, the fuser 60 fixes the toner image on the paper.

The paper conveyor 50 includes a paper feeder 51, a paper delivery unit 52, and a conveyance route 53, and the like. Paper (standard paper, special paper) distinguished based on weight, size, etc. is classified into predetermined types and held in three feed tray units 51a to 51c that constitute the paper feeder 51. The conveyance route 53 includes pairs of conveyance rollers such as a pair of resist rollers 53a.

The top sheet of paper held in the feed tray units 51a to 51c is sent out one by one and conveyed to the image former 40 through the conveyance route 53. At this time, a resist roller portion provided with the pair of resist rollers 53a corrects inclination of the fed paper and adjusts conveyance time. Then, the image former 40 secondarily transfers a toner image of the intermediate transfer belt 421 to one side of paper at once. The fuser 60 performs a fixing step. The paper delivery unit 52 having ejection rollers 52a discharges paper on which an image is formed out of the machine.

Paper may be long paper or roll paper. In those cases, the paper is held in a feed device (not shown) connected to the image forming device 1. The paper held in the feed device is supplied to the image forming device 1 from the feed device via a paper entrance 54, and is sent to the conveyance route 53.

The memory 70 is, for example, nonvolatile semiconductor memory (so-called flash memory) or a hard disk drive. The memory 70 stores various data such as information of various settings for the image forming device 1.

The communicator 80 consists of a communication control card such as a LAN (local area network) card. The communicator 80 transmits and receives various data to and from external devices, such as a computer, connected to a communication network such as a LAN or WAN (wide area network).

Jobs printed by the image forming device 1 are entered by a user from the operation interface 22, or are received from external devices by the communicator 80. The operation interface 22 and the communicator 80 function as a job entry unit.

The controller 100 includes a CPU (central processing unit) 101, ROM (read only memory) 102, and RAM (random access memory) 103. The CPU 101 reads a program suitable for content of processing from the ROM 102, and develops it in the RAM 103. The CPU 101 cooperates with the developed program to comprehensively control operation of blocks of the image forming device 1 in FIG. 2.

For example, the controller 100 performs link setting processing, job edit processing, automatic change processing for contents of associated items, and mismatch notification processing for contents of associated items, which will be described later, to function as a link setter, an association setter, a display controller, and an automatic changer.

The image processor 30 and the controller 100 function as an image processing device 1000.

The RAM 103 provides a work area in which various programs executed by the controller 100 and various data related to the programs are temporarily stored.

A job consists of image data and setting information of print condition for printing based on the image data. Printing by the image former 40 based on a job is expressed as “performing a job” or “printing a job”.

Operation of Image Forming Device 1

Next, operation according to the embodiment will be described. According to the image forming device 1 of the embodiment, a link is set between jobs displayed on a job list screen in the link setting processing for jobs described below.

Link Setting Processing for Jobs

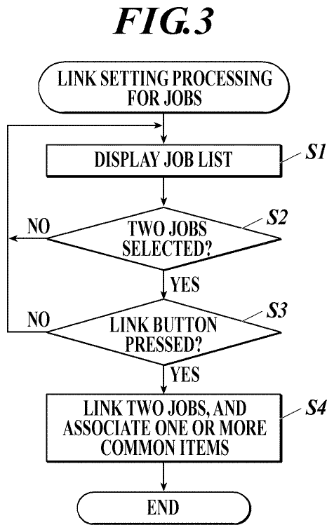

FIG. 3 shows a flowchart of link setting processing for jobs performed by the image forming device 1. The controller 100 cooperates with a program stored in the ROM 102 to perform the link setting processing for j obs in response to operation of the operation interface 22.

First, the controller 100 displays a job list screen 211 on the display 21 (Step 51). Jobs entered by the job entry unit are displayed on the job list screen 211.

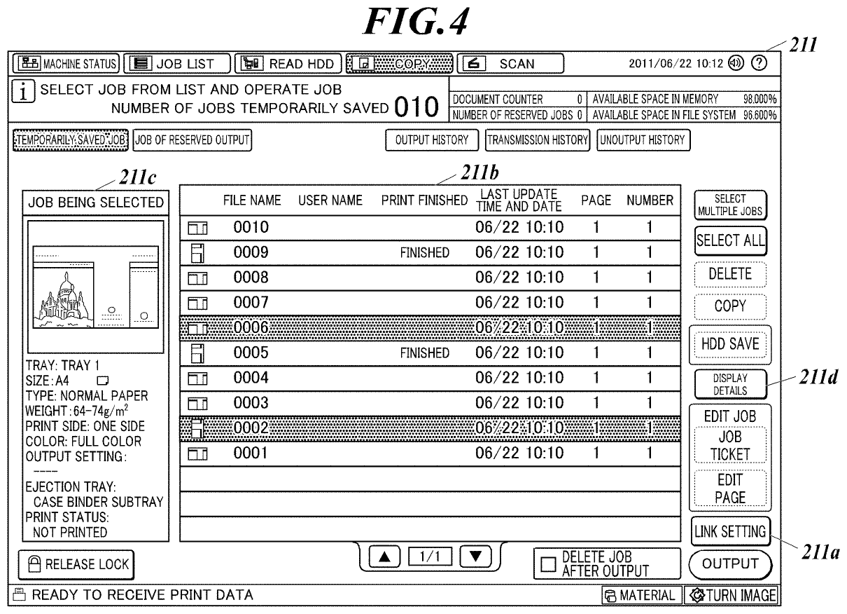

FIG. 4 shows an example of the job list screen 211. The job list screen 211 is a screen for setting a link between displayed jobs. As shown in FIG. 4, the job list screen 211 includes a link setting button 211a, a job list column 211b, a selected job detail column 211c, and a detail display button 211d.

The link setting button 211a is a button for ordering a link setting between displayed jobs. Setting a link means associating jobs with each other while keeping each of the jobs independent.

The job list column 211b is an area where a list of jobs is displayed. The selected job detail column 211c is an area where detailed information of a job selected from the job list column 211b is displayed. The detail display button 211d is a button for ordering display of details of a selected job.

Next, the controller 100 determines whether two jobs displayed by the operation interface 22 are selected on the job list screen 211 (Step S2). In a case where the controller 100 determines that two jobs are not selected (NO in Step S2), the controller 100 returns processing to Step S1. In a case where the controller 100 determines that two jobs are selected (YES in Step S2), the controller 100 displays the selected jobs in a status for selected ones (reverse display).

Next, the controller 100 determines whether the link setting button 211a is operated by the operation interface 22 (Step S3). In a case where the controller 100 determines that the link setting button 211a is not operated (NO in Step S3), the controller 100 returns processing to Step S1. In a case where the controller 100 determines that the link setting button 211a is operated (YES in Step S3), the controller 100 performs the link setting for the selected jobs (Step S4). At this time, the controller 100 performs the association setting of associating some items common the two jobs. The memory 70 stores information of the link setting and the association setting. Items to be associated are pre-set.

Items to be associated may be set manually by a user, or may be automatically set by a program according to purposes. Users are free to change items on which the association setting has been performed.

Job Edit Processing

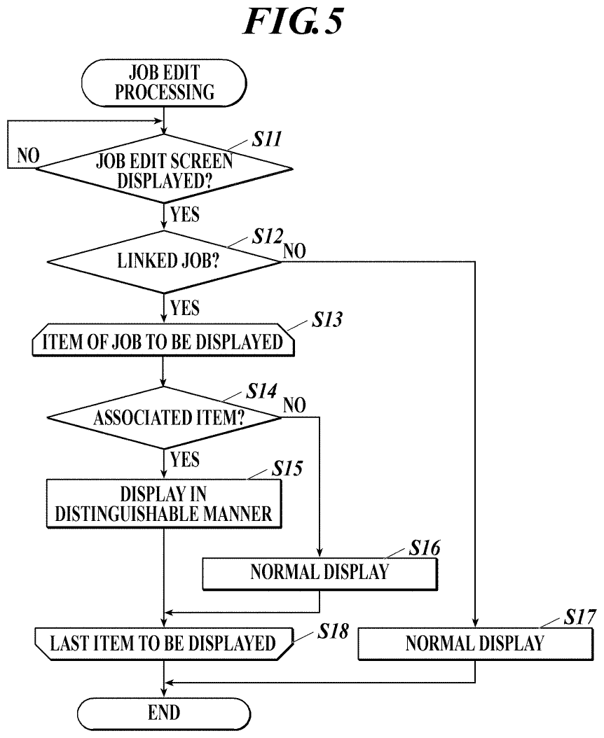

FIG. 5 is a flowchart showing job edit processing. The controller 100 cooperates with a program stored in the ROM 102 to perform the processing.

First, the controller 100 determines whether the job information edit screen is displayed (step S11). In a case where the controller 100 determines that the job information edit screen is not displayed (NO in step S11), the controller 100 returns processing to step S11. In a case where the controller 100 determines that the job information edit screen is displayed (YES in step S11), the controller 100 determines whether the link setting is performed on a job to be displayed next on the job information edit screen (step S12). In a case where the controller 100 determines that the link setting is not performed on the job to be displayed (NO in Step S12), the controller 100 performs normal display of the job (Step S17).

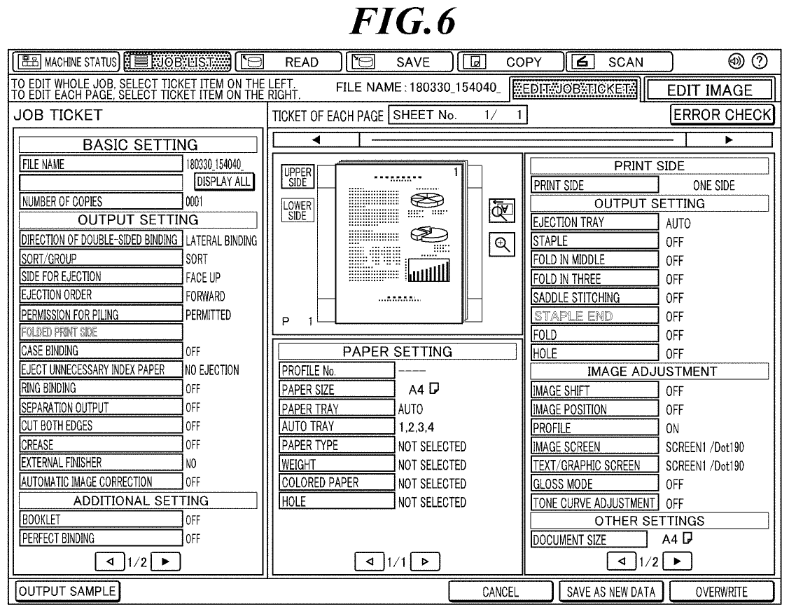

FIG. 6 shows an example of a ticket information edit screen of the normal display.

In a case where the controller 100 determines that the link setting is performed on the job to be displayed (YES in Step S12), the controller 100 determines whether items of the job to be displayed are associated items (Step S14). To display associated items (YES in Step S14), the controller 100 displays the associated items and unassociated items in a distinguishable manner (Step S15). To display unassociated items (NO in Step S14), the controller 100 performs the normal display (Step S16). After the controller 100 finishes processing of Step S14 and Step S15 or Step S16 (Step S13 to Step S18) for all the displayed items, the controller 100 ends control.

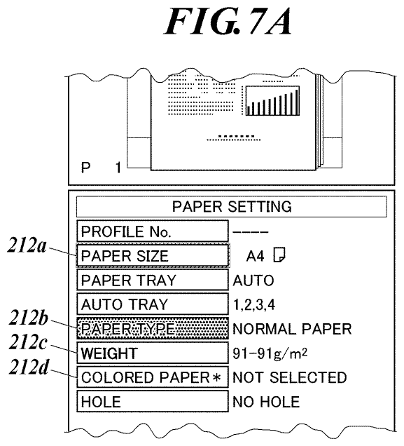

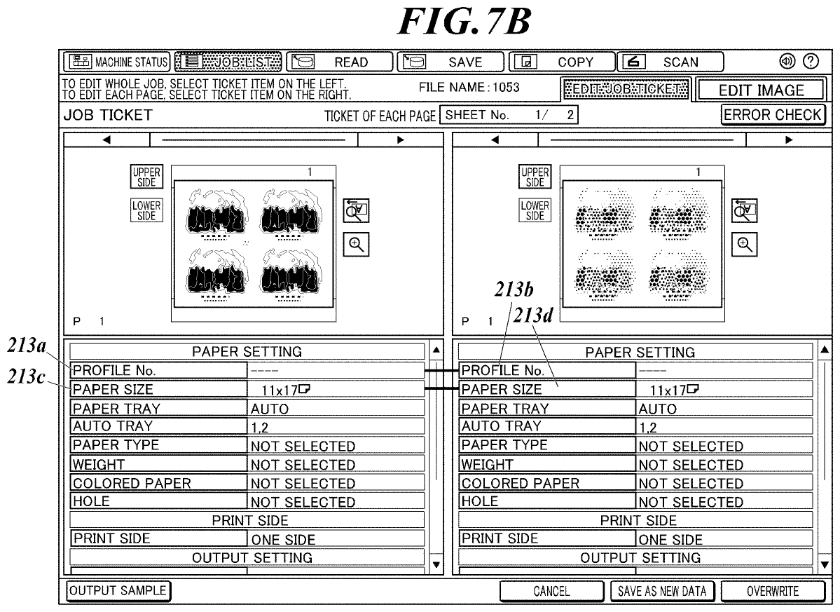

FIG. 7A and FIG. 7B show examples in which the associated items and the unassociated items in the flowchart showing the job edit processing are displayed in the distinguishable manner (Step S15).

In FIG. 7A, the associated items are “paper size”, “paper type”, “weight” and “colored paper”. In the embodiment, a paper size button 212a is surrounded by a different color. A color of a paper type button 212b is changed. A font of letters on a weight button 212c is changed. A mark is put on a colored paper button 212d. Thus, the associated items are distinguished from the unassociated items.

In FIG. 7B, the associated items are “profile No.” and “paper size”. In the embodiment, two jobs on which the link setting is performed are displayed at once on the left and right. Profiles of the associated items are connected by lines. Thus, the associated items are distinguished from the unassociated items. Profile No. buttons 213a, 213b, and paper size buttons 213c, 213d of the two jobs are connected by lines.

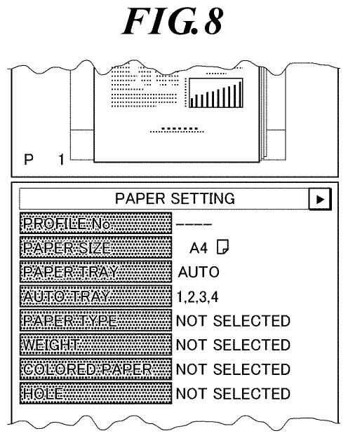

In a case where job information of only one of the two jobs on which the link setting is performed can be displayed, the controller 100 performs control so that the associated items of only the first job of the two jobs can be edited. As shown in FIG. 8, the controller 100 shades item buttons of items of the second job of the two jobs which are not allowed to be edited. Thus, a user knows that the items are not allowed to be edited. The unassociated items of the two jobs can be edited.

Alternatively, a button for moving from the job information edit screen of the first job to the job information edit screen of the second job may be given. In that case, the associated items and the unassociated items of both two jobs can be edited.

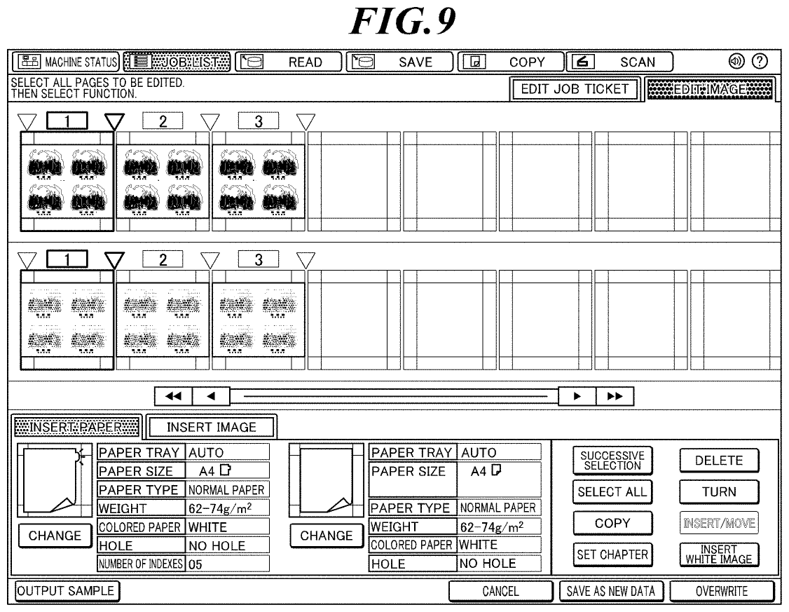

On the other hand, in a case where two jobs on which the link setting is performed are displayed at once as shown in FIG. 9, the controller 100 performs control so that associated items and unassociated items of both two jobs can be edited.

Automatic Change Processing for Contents of Associated Items

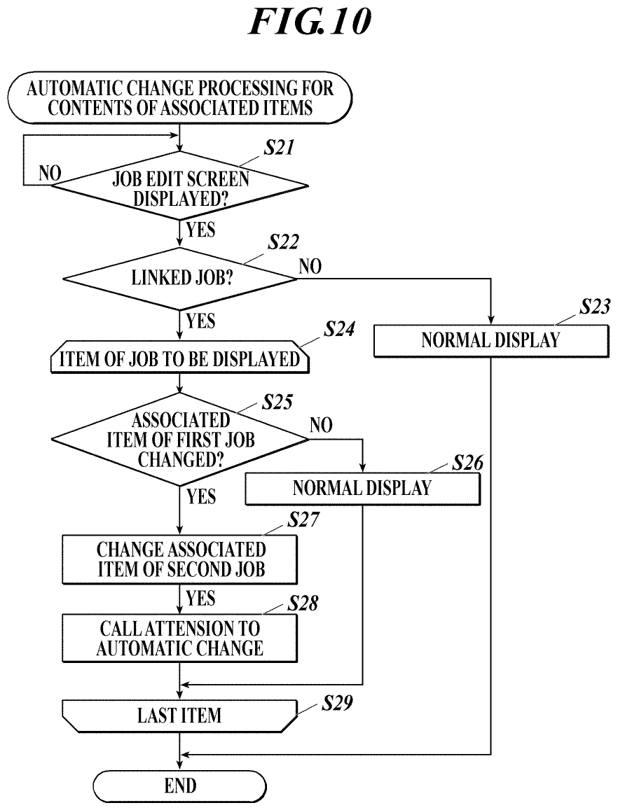

FIG. 10 is a flowchart showing automatic change processing for contents of associated items. The controller 100 and the operation interface cooperate with a program stored in the ROM 102 to perform the processing.

First, the controller 100 determines whether the job information edit screen is displayed (Step S21). In a case where the controller 100 determines that the job information edit screen is not displayed (NO in Step S21), the controller 100 returns processing to Step S21. In a case where the controller 100 determines that the job information edit screen is displayed (YES in Step S21), the controller 100 determines whether the link setting is performed on a job to be displayed next on the job information edit screen (Step S22). In a case where the controller 100 determines that the link setting is not performed on the job to be displayed (NO in Step S22), the controller 100 performs the normal display of job information (Step S23) and ends control.

In a case where the controller 100 determines that the link setting is performed on the job to be displayed (YES in Step S22), the controller 100 determines whether contents of associated items of a first job are changed, the first job being one of the two jobs on which the link setting is performed (Step S25). In a case where the contents are not changed (NO in Step S25), the controller 100 performs the normal display of job information (Step S26). In a case where the contents are changed (YES in Step S25), the controller 100 changes contents of the associated items of the second job to the changed contents of the associated items of the first job, the second job being the other of the two jobs on which the link setting is performed (Step S27).

The controller 100 calls attention to automatic change in the contents of the second job as a first attention indication (Step S28).

After the controller 100 finishes processing of Step S25 to Step S28 (Step S24 to Step S29) for all the displayed items of the jobs, the controller 100 ends control.

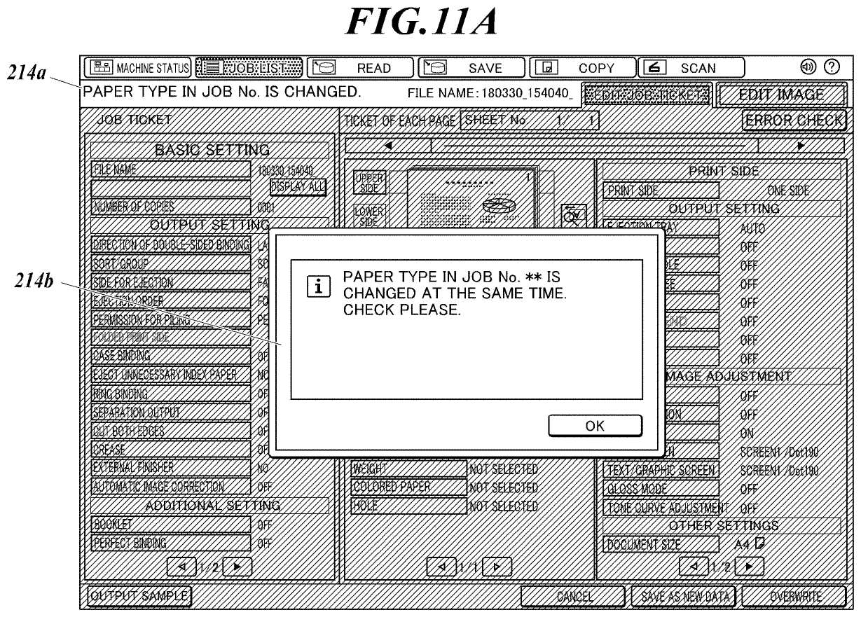

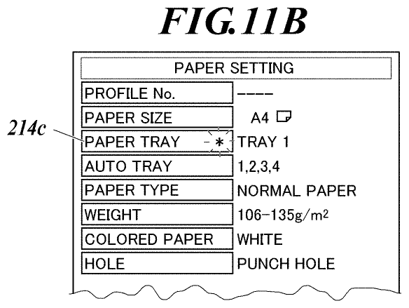

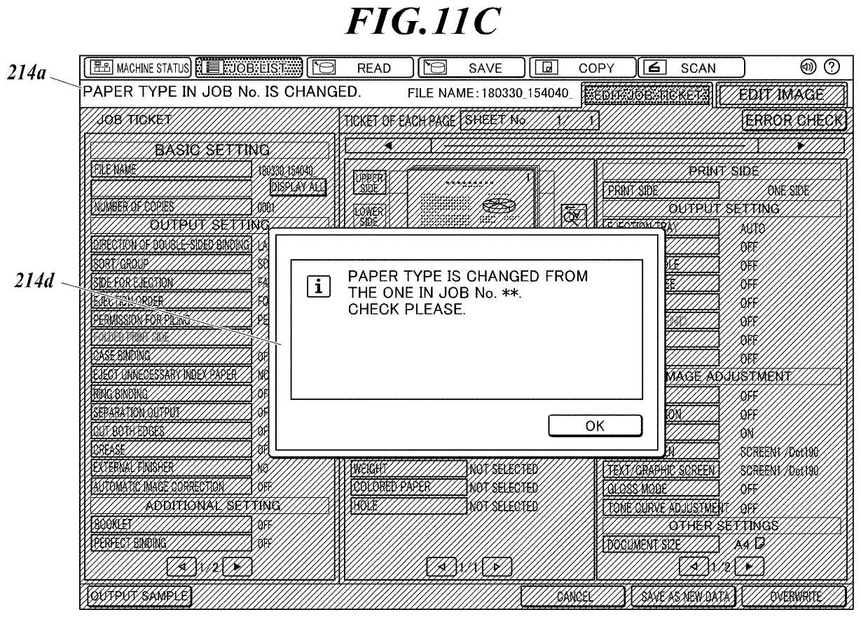

FIG. 11A and FIG. 11B show examples of the first attention indication (Step S28).

In FIG. 11A, a one-shot message 214a is displayed on the screen and is erased after a predetermined time. Alternatively, a message is displayed on a pop-up screen 214b. The pop-up screen 214b is erased by pressing an OK button.

In FIG. 11B, a mark put on an item button 214c of an item of the second job flashes, the item having been automatically changed. Alternatively, the item button 214c itself may flash.

The controller 100 may call attention to automatic change in contents of items of the second job when the second job is opened after the contents are changed. FIG. 11C shows an example. In FIG. 11C, a pop-up screen 214d for calling attention is displayed.

Modification

In the automatic change processing for contents of associated items according to the embodiment, if contents of the associated items of the first job of the two jobs on which the link setting are performed are changed, the contents of the associated items of the second job are automatically changed. Instead of automatically changing contents, the controller 100 may call attention to mismatch between contents of associated items of two jobs.

Processing for that will be described below.

Mismatch Notification Processing for Contents of Associated Items

FIG. 10 is a flowchart showing mismatch notification processing for contents of associated items. The controller 100 and the operation interface cooperate with a program stored in the ROM 102 to perform the processing.

First, the controller 100 performs Step S31 to Step S36 which are similar to Step S21 to Step S26 in the automatic change processing for contents of associated items.

Next, in a case where contents of the associated items of the first job of the two jobs on which the link setting is performed is changed (YES in step S35), the controller 100 determines whether contents of the associated items of the two jobs match (step S37). In a case where the contents match (YES in step S37), the controller 100 proceeds to step S36. Ina case where the contents do not match (NO in step S37), the controller 100 calls attention to mismatch between the contents of the associated items of the two jobs as a second attention indication (step S38).

After the controller 100 finishes processing of Step S35 to Step S38 (Step S34 to Step S39) for all the displayed items of the jobs, the controller 100 ends control.

The method of displaying the second attention indication (step S38) is the same as that of the first attention indication. The controller 100 calls attention by displaying the one-shot message 214a, displaying the pop-up screen 214b, flashing the mark put on the item button 214c of a mismatch item, or flashing the item button 214c itself, as shown in FIG. 11A and FIG. 11B.

Alternatively, the controller 100 may call attention to mismatch between the contents of the associated items in error check before the job is printed.

In the case where the contents of the associated items of the two jobs do not match, a user is free to decide which contents of the two jobs will be adopted.

As described above, the controller 100 of the image forming device 1 associates jobs with each other while keeping each of the jobs independent. The controller 100 associates at least one of items common to associated j obs. Therefore, contents of items of jobs on which the link setting is performed are efficiently edited.

To display job information of jobs on which the link setting is performed on the display 21, the controller 100 displays associated items and unassociated items of the jobs in the distinguishable manner

Therefore, a user can distinguish between associated items and unassociated items of the jobs, and can easily recognize job information.

After the controller 100 changes contents of associated items of a first job of the jobs on which the link setting is performed, the controller 100 calls user's attention in:

a case where the controller 100 automatically changes contents of the associated items of a second job to the changed contents of the first job; and a case where the controller 100 does not automatically change contents of the second job so that contents of the associated items of the jobs remain mismatched.

Therefore, a user can easily recognize automatic change in contents of the associated items, or mismatch between contents of the associated items.

The embodiment and the modification show preferable examples of an image forming device according to the present invention. The present invention is not limited thereto.

Although the image processing device is provided with the image former in the embodiment and the modification, the present invention is not limited thereto. The image processing device may be separate from the image former.

Although the number of jobs to be linked is two in the embodiment and the modification, the present invention is not limited thereto. More than two jobs may be linked.

Details of configuration and operation of the image forming device 1 may be appropriately modified within the scope of the claims of the present invention.

Although embodiments of the present invention have been described and illustrated in detail, the disclosed embodiments are made for purposes of illustration and example only and not limitation. The scope of the present invention should be interpreted by terms of the appended claims

The entire disclosure of Japanese patent application No. 2020-081661, filed on May 7, 2020, is incorporated herein by reference in its entirety.

What is claimed is:

1. An image processing device, comprising:
a job entry unit that enters jobs;
a link setter that associates the jobs entered by the job entry unit; and
an association setter that associates one or more items common to the associated jobs.

2. The image processing device according to claim 1, further comprising:
a display that displays job information of at least one of the jobs; and
a display controller that displays the associated items of the jobs in such a manner that the associated items are distinguishable from unassociated items of the jobs on the display.

3. The image processing device according to claim 2, wherein the display controller displays letters or buttons of the associated items of the jobs in a color different from that of the unassociated items.

4. The image processing device according to claim 2, wherein the display controller displays letters of the associated items of the jobs in thickness or a font different from that of the unassociated items.

5. The image processing device according to claim 2, wherein the display controller puts predetermined marks only on the associated items of the jobs.

6. The image processing device according to claim 2, wherein the display controller displays job information of both the two associated jobs on the display, and the display controller displays a line connecting the associated items in the job information of the two associated jobs.

7. The image processing device according to claim 2, further comprising:
an automatic changer that, in a case where contents of the associated items of a first job of the jobs are changed, automatically changes contents of the associated items of a second job of the jobs.

8. The image processing device according to claim 7, wherein in a case where the automatic changer changes the contents of the associated items of the second job, the display controller displays first attention indication that indicates change in the contents.

9. The image processing device according to claim 8, wherein the first attention indication is pop-up display, status message display, or flashing of the associated items of the jobs.

10. The image processing device according to claim 2, wherein, in a case where contents of the associated items of the first job of the jobs are changed, the display controller displays a second attention indication that indicates mismatch between contents of the associated items of the jobs on the display.

11. The image processing device according to claim 10, wherein the second attention indication is pop-up display, status message display, flashing of the associated items of the jobs, or error check display.

12. The image processing device according to claim 2, wherein the association setter sets items of the jobs which are to be associated based on user operation.

13. The image processing device according to claim 2, wherein the association setter sets items of the jobs which are to be associated based on a purpose.

14. The image processing device according to claim 2, wherein, in a case where contents of items of the jobs which are to be associated do not match, the association setter matches the contents with each other based on user operation before associating the items.

15. The image processing device according to claim 2, wherein the display controller displays contents of the associated items of the jobs on the display, and changes the displayed contents based on user operation.

16. The image processing device according to claim 2, wherein
the display controller displays job information of a first job of the jobs on the display,
the display controller changes display of the job information of the first job to display of job information of a second job of the jobs, and
the display controller changes contents of items of both the jobs based on user operation.

17. An image forming device, comprising:
the image processing device according to claim 1; and
an image former that forms images on paper.

18. A non-transitory recording medium storing a computer readable program that makes a computer of an image processing device function as:
a job entry unit that enters jobs;
a link setter that associates the jobs entered by the job entry unit; and
an association setter that associates one or more items common to the associated jobs.
